(19) United States
(12) Patent Application Publication
(10) Pub. No.: US 2004/0233031 A1
(43) Pub. Date: Nov. 25, 2004

(54) Electromagnetic interference suppressor

(76) Inventors: Hermann Allison, Pretoria (ZA); Ronald Kevin Fricker, Pretoria (ZA); Marthinus Christoffel Smit, Pretoria (ZA); Ivan William Hofsajer, Johannesburg (ZA)

Correspondence Address: FINNEGAN, HENDERSON, FARABOW, GARRETT & DUNNER, LLP, 1300 I STREET, NW, WASHINGTON, DC, 20005, US

(21) Appl. No.: 10/485,223

(22) PCT Filed: Jul. 31, 2002
(86) PCT No.: PCT/ZA02/00122

(30) Foreign Application Priority Data
Jul. 31, 2001 (ZA) 2001/6294

(51) Int. Cl. H01F 5/00; H01F 27/28

(52) U.S. Cl. 336/200; 336/223; 336/232

(57) ABSTRACT

A system (10) comprising a planar transformer winding (16) also comprises an electromagnetic interference (EMI) suppressor arrangement (24) for suppressing common mode EMI generated by the transformer winding. The suppressor arrangement comprises a planar winding (28) which, in use, is energized in anti-phase relative to the system winding. The arrangement being such that the winding arrangement (24) is exposed to the system winding via a dielectric medium, thereby to provide capacitive coupling between the suppressor winding arrangement and the system, to suppress EMI generated by the system winding.

### TECHNICAL FIELD

THIS invention relates to electromagnetic interference suppressors. It more particularly relates to such suppressors for systems comprising planar magnetic components or windings.

### BACKGROUND ART

A major disadvantage of switch mode power electronics supplies comprising planar magnetic components is the high parasitic capacitance that the planar windings exhibit. The capacitance manifests itself in two main areas, the capacitance between the windings of a multiple winding component and the capacitance to the surroundings. It is the capacitance to the surroundings that is a major contributing factor to common mode electromagnetic interference of the system. The common mode EMI of a system with planar magnetic components is significantly larger than that of a similar system with conventional magnetic components. This necessitates the use of large common mode filters in order to reduce the EMI to within the relevant allowable standards. These common mode filters contribute significantly to the size and cost of the overall system, especially at moderate to low powers.

### OBJECT OF THE INVENTION

Accordingly it is an object of the present invention to provide a system, EMI suppressor and method of suppressing EMI with which the applicants believe the aforementioned disadvantages may at least be alleviated.

### SUMMARY OF THE INVENTION

According to the invention there is provided a system comprising a system winding and an electromagnetic interference (EMI) suppressor, the suppressor comprising a winding arrangement which, in use, is energized in anti-phase with the system winding, the arrangement being such that the winding arrangement is exposed to the system winding via a dielectric medium, thereby to provide capacitive coupling between the suppressor winding arrangement and the system winding.

The system winding is preferably a planar winding and the suppressor winding arrangement preferably comprises an elongate element formed in a planar winding.

The suppressor winding arrangement may be connected at one end thereof to a substantially constant voltage and another end thereof may be floating.

The winding arrangement may terminate at said other end in a conductive pad.

The element may towards said other end of the winding have a larger surface area exposed to the system winding than towards said one end.

The system winding may be formed on at least one planar substrate.

In one embodiment a first part of the system winding is provided on a first planar substrate and a second part of the system winding is provided on a second planar substrate superimposed on the first substrate. The first part of the system winding may be galvanically connected to the second part of the system winding by through holes in the first and second substrates.

The suppressor winding arrangement may be formed on a further planar substrate superimposed on the first and second substrates. The aforementioned pad of the suppressor winding arrangement may be provided on a yet further planar substrate of a laminated structure also comprising said first, second and further substrates.

The first and second substrates may be sandwiched between the further and yet further substrates and a winding of the suppressor winding arrangement on the further substrate is preferably galvanically connected to the pad on the yet further substrate by through holes in the first and second substrates.

The system may comprise a transformer arrangement and the system winding may comprise a primary winding of the transformer arrangement. The system may further comprise a switch mode circuit for driving the primary winding of the transformer arrangement.

Also included within the scope of the present invention is an electromagnetic interference (EMI) suppressor for a system comprising a system winding, the suppressor comprising a winding arrangement which, in use, is energized in anti-phase with the system winding, the suppressor winding arrangement being mountable, in use, relative to the system winding such that the suppressor winding arrangement and system winding provide capacitive coupling via a dielectric medium between the suppressor winding arrangement and the system winding.

Yet further included within the scope of the present invention is a method of suppressing electromagnetic interference (EMI) in a system comprising a system winding, the method comprising the steps of:

energizing a suppressor winding arrangement in anti-phase to the system winding;

providing capacitive coupling between the suppressor winding arrangement and at least part of the system through a dielectric medium between the system winding and the suppressor winding arrangement,

thereby to suppress EMI generated by the system.

The system winding is preferably planar and the suppressor winding arrangement preferably comprises an elongate element formed in a planar winding.

The suppressor winding arrangement is preferably energized by magnetic induction from the system winding.

The suppressor winding arrangement may comprise a region having a surface area exposed to the system winding.

Further according to the method, EMI suppression may be trimmable by suitable adjustment of at least one of a number of windings of the suppressor winding arrangement and a size of said surface area.

### BRIEF DESCRIPTION OF THE ACCOMPANYING DIAGRAMS

The invention will now further be described, by way of example only, with reference to the accompanying diagrams wherein:

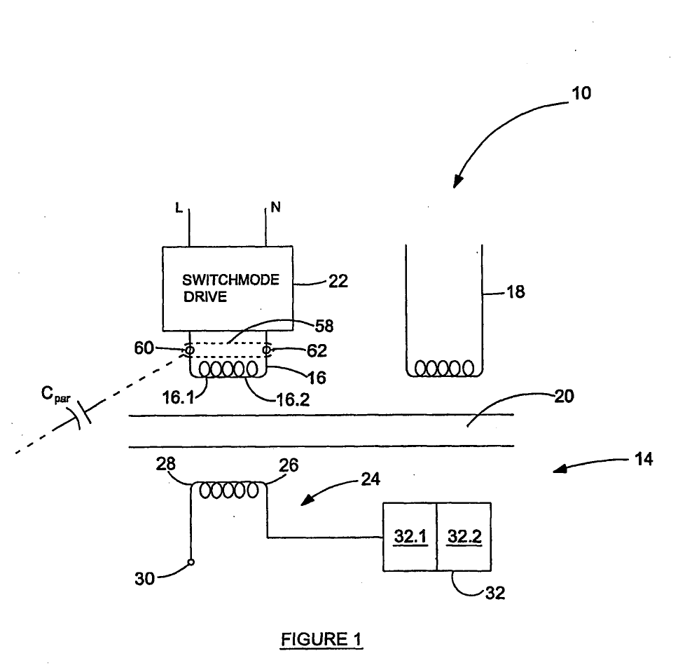

FIG. 1 is a block diagram of a switch mode driven power supply system comprising a transformer arrangement and an electromagnetic interference suppressor according to the invention;

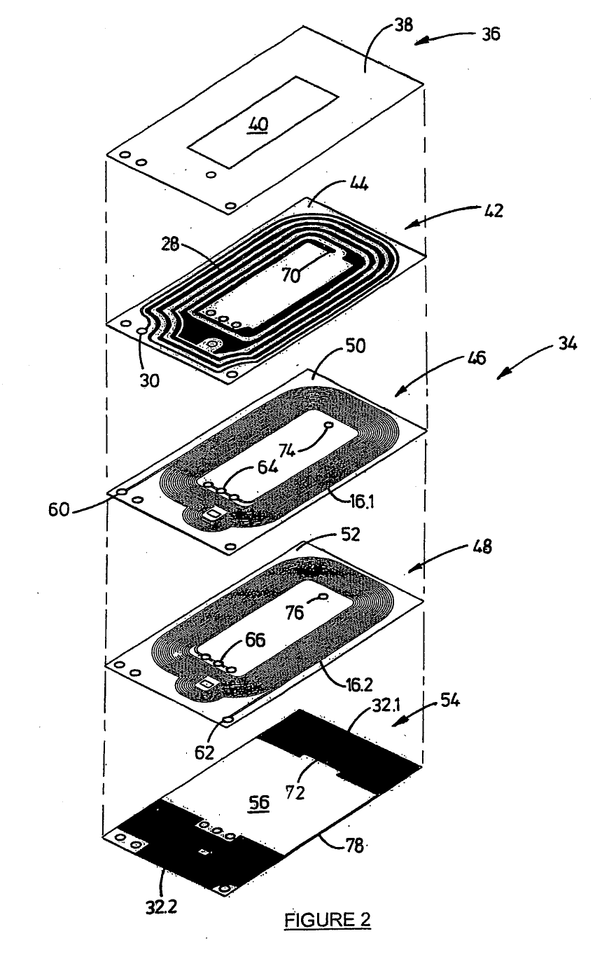

FIG. 2 is an exploded perspective view of a plurality of layers from top to bottom of a laminated system comprising an electromagnetic interference suppressor according to the invention; and

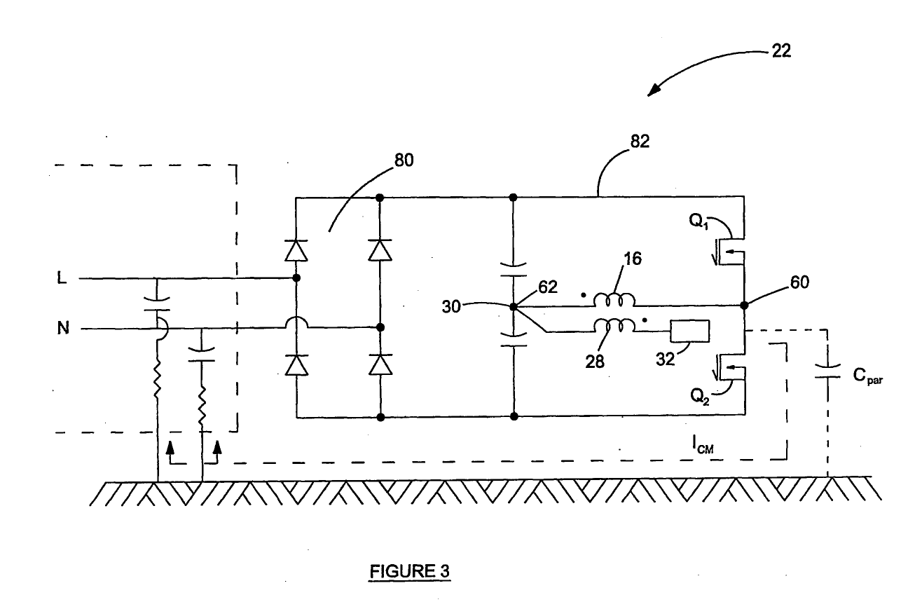

FIG. 3 is a circuit diagram of relevant parts only of a switch mode driven system comprising the suppressor according to the invention.

### DESCRIPTION OF A PREFERRED EMBODIMENT OF THE INVENTION

In FIG. 1 a block diagram of a switch mode driven power supply system according to the invention comprising a transformer arrangement 12 and an electromagnetic interference (EMI) suppressor 14 is shown at 10.

The transformer arrangement 12 comprises a primary winding 16, a secondary winding 18 and a core 20. The primary winding is preferably of a planar configuration as will hereinafter be described with reference to FIG. 2. The secondary may in some applications comprise a single winding.

The primary winding is connected to be driven by switch mode power electronics circuitry 22. The circuitry in turn is connected to live (L) and neutral (N) of mains AC power. As explained in the introduction of this specification, due to the switching and parasitic capacitance Cₚₐᵣ, common mode electromagnetic interference (EMI) is caused on the lines L and N.

The EMI suppressor 14 according to the invention comprises a suppressor winding arrangement 24 comprising an elongate element 26 formed in a multiple winding 28 and connected at one end 30 thereof to a substantially constant voltage point and at the other end it is galvanically connected to and terminates in a conductive, but floating pad 32. The winding 28 is energized in at least partial, but preferably substantial anti-phase relative to the winding 16. The suppressor winding may be energized through magnetic induction from winding 16, alternatively it may be driven separately. The anti-phase may be achieved in known manner by appropriate winding direction and/or electrical connection.

In FIG. 2 there are shown five layers of a laminated arrangement 34 forming part of the system 10. A top layer 36 comprises a substrate 38 defining a hole 40 for core 20 (shown in FIG. 1) of a suitable magnetic material. A next layer 42 comprises a substrate 44 and the conductive planar multiple winding or coil 28 of the suppressor winding arrangement 24 is provided thereon.

Still further layers 46 and 48 comprise substrates 50 and 52 respectively. Substrate 50 carries a first part 16.1 of primary winding 16 and substrate 52 carries a second part 16.2 of primary winding 16.

A last layer 54 comprises a substrate 56 on which there are provided first part 32.1 and second part 32.2 of conductive pad 32 of the suppressor winding arrangement 24.

An input 58 for the primary winding 16 is provided between terminals 60 and 62. First winding part 16.1 is formed from terminal 60 in a clock-wise direction and is connected via conductively cladded through-holes 64 in substrate 50 to registering conductively cladded through-holes 66 connected on an inside of second winding part 16.2. Winding part 16.2 is also formed in a clockwise direction and terminates in the aforementioned terminal 62.

Winding 28 of the suppressor is also formed in a clock-wise direction from terminal 30 to terminate in inside terminal 70. Inside terminal 70 is connected to terminal 72 on first pad part 32.1 via conductively cladded through-hole 74 in substrate 50 and registering conductively cladded through-hole 76 in substrate 52. First pad part 32.1 is also connected to second pad part 32.2 by link 78. In use, terminal 30 is connected to a substantially constant voltage point as will hereinafter be described, while the pad 32 is left floating.

The conductive parts on the aforementioned substrates are provided in known manner (such as known PC board etching techniques) on the non-conductive substrates. The substrates are sandwiched together to form the laminated structure 34 shown in exploded form in FIG. 2.

An example of a switch mode drive 22 in the form of a switch mode converter for lighting applications is shown in more detail in FIG. 3. The drive is powered via a mains AC fed rectifier 80. DC voltage at 82 is converted to a high frequency substantially square wave, by complementary switching of transistors Q1 and Q2 by circuitry (not shown). The square wave is applied to input 58 of primary winding 16 with terminals 60 and 62. Terminal 60 slews at a high rate between a high voltage and a low voltage in sympathy with the switching of the transmissions Q1 and Q2. Terminal 62, however is at a substantially constant voltage. Terminal 30 of suppressor winding arrangement 24 is connected to terminal 62. The aforementioned problematic parasitic capacitance Cₚₐᵣ, the common mode current and its path to the gird are also shown in broken lines in FIG. 3.

To counteract this common mode current, it is proposed to maintain a charge balance within the transformer 12. Hence, the assembly 34 of FIG. 2. The voltage gradient from 60 to 62 is generally linear if edge effects are neglected. Therefore the current distribution will have a similar profile if the self-capacitance is evenly distributed along the winding 16. The suppressor winding 28 is introduced in the transformer 12 and is energized in at least partial, but preferably substantial anti-phase with winding 16, as the dot convention in FIG. 3 clearly illustrates. With terminal 30 connected to terminal 62, the voltage on the pad 32 will swing with a polarity opposite to that of point 60. During the slewing of the terminal 60 and pad 32, the positive increase in charge required by the self capacitance of the one winding 16, 28 is balanced by the negative increase of that of the other winding 28, 16. Under such conditions there is no need for any common mode current to flow externally of the system and hence the EMI suppression.

In order for the aforementioned charge balance to be maintained, it is not necessary to have windings 16 and 28 that are identical in construction. However, the condition that must be satisfied is that

C₁V₁=C₂V₂

wherein

C₁ is the capacitance of winding 16.

V₁ is the voltage swing of terminal 60.

C₂ is the capacitance of winding 28.

V₂ is the voltage swing of pad 32.

As the self-capacitance of a winding to the surroundings depends on the exposed surface area, it is generally sufficient that the winding 28 take up one layer of winding 16 only. The aforementioned equation also makes it clear that a desired level of EMI suppression may be designed for or trimmed by selecting suitable values for the size of pad 32 and the number of windings in winding arrangement 24. With C₂ and V₂ such that the EMI generated by the primary winding is over compensated for, this overcompensation may serve to compensate for EMI generated by other parts of the system in the proximity of the suppressor winding arrangement.

It is believed that the suppressor and method according to the invention may in particular find application in switch mode power supplies comprising planar magnetic components. Accordingly, such power supplies comprising the suppressor according to the invention are also included within the scope of the invention.

1. A system comprising a system winding and an electromagnetic interference (EMI) suppressor, the suppressor comprising a winding arrangement which, in use, is energized in anti-phase with the system winding, the arrangement being such that the winding arrangement is exposed to the system winding via a dielectric medium, thereby to provide capacitive coupling between the suppressor winding arrangement and the system winding.

2. A system as claimed in claim 1 wherein the system winding is a planar winding and wherein the suppressor winding arrangement comprises an elongate element formed in a planar winding.

3. A system as claimed in claim 1 or claim 2 wherein the suppressor winding arrangement is connected at one end thereof to a substantially constant voltage and another end thereof is floating.

4. A system as claimed in claim 3 wherein the winding arrangement terminates at said other end in a conductive pad.

5. A system as claimed in claim 3 or claim 4 wherein the element towards said other end of the winding has a larger surface area exposed to the system winding than towards said one end.

6. A system as claimed in any one of claims 2 to 5 wherein the system winding is formed on at least one planar substrate.

7. A system as claimed in claim 6 wherein a first part of the system winding is provided on a first planar substrate and a second part of the system winding is provided on a second planar substrate superimposed on the first substrate.

8. A system as claimed in claim 7 wherein the first part of the system winding is galvanically connected to the second part of the system winding by through holes in the first and second substrates.

9. A system as claimed in any one of claims 6 to 8 wherein at least part of the suppressor winding arrangement is formed on a further planar substrate superimposed on the first and second substrates.

10. A system as claimed in claim 9 wherein a pad of the suppressor winding arrangement is provided on a yet further planar substrate.

11. A system as claimed in claim 10 wherein the first and second substrates are sandwiched between the further and yet further substrates and wherein a winding of the suppressor winding arrangement on the further substrate is galvanically connected to the pad on the yet further substrate by through holes in the first and second substrates.

12. A system as claimed in any one of the preceding claims wherein the system comprises a transformer and wherein the system winding is a primary winding of the transformer.

13. A system as claimed in claim 12 wherein the system comprises a switch mode circuit for driving the primary winding of the transformer.

14. An electromagnetic interference (EMI) suppressor for a system comprising a system winding, the suppressor comprising a winding arrangement which, in use, is energized in anti-phase with the system winding, the suppressor winding arrangement being mountable in use relative to the system winding such that the suppressor winding arrangement and system winding provide capacitive coupling via a dielectric between the suppressor winding arrangement and the system winding.

15. A method of suppressing electromagnetic interference (EMI) in a system comprising a system winding, the method comprising the steps of:
energizing a suppressor winding arrangement in anti-phase to the system winding;
providing capacitive coupling between the suppressor winding arrangement and at least part of the system through a dielectric medium between the system winding and the suppressor winding arrangement,
thereby to suppress EMI generated by the system.

16. A method as claimed in claim 15 wherein the system winding is planar and the suppressor winding arrangement comprises an elongate element formed in a planar winding.

17. A method as claimed in any one of claims 15 and 16 wherein the suppressor winding arrangement is energized by magnetic induction from the system winding.

18. A method as claimed in any one of claims 15 to 17 wherein the suppressor winding arrangement comprises a region having a surface area exposed to the system winding.

19. A method as claimed in claim 18 wherein EMI suppression is trimmable by suitable adjustment of at least one of a number of windings of the suppressor winding arrangement and a size of said surface area.
